(19) United States
(12) Patent Application Publication
(10) Pub. No.: US 2005/0018748 A1
(43) Pub. Date: Jan. 27, 2005

(54) Actively quenched lamp, infrared thermography imaging system, and method for actively controlling flash duration

(76) Inventors: Harry Israel Ringermacher, Delanson, NY (US); Richard S. Zhang, Rexford, NY (US); Robert John Filkins, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/627,206

(22) Filed: Jul. 24, 2003

(51) Int. Cl. G01J 5/00

(52) U.S. Cl. 374/121

(57) ABSTRACT

An actively quenched lamp includes a lamp and an active quenching means configured to quench the lamp. An infrared (“IR”) thermography imaging system includes at least one lamp configured to heat a surface of an object to be imaged, at least one active quenching means configured to quench the lamp, and an IR camera configured to capture a number of IR image frames of the object. A method, for actively controlling flash duration for IR thermography, includes generating an initial control signal T0, a lamp control signal T1, and a control signal T2. The method further includes activating a quenching means in response to initial control signal T0, to allow current I to flow to a lamp, activating the lamp in response to lamp trigger signal T1, and turning off the quenching means in response to control signal T2 to cut off the current I to the lamp.

### BACKGROUND OF THE INVENTION

The invention relates generally to infrared (“IR”) thermography and, more particularly, to actively controlling the flash duration of an IR lamp for an IR thermography imaging system.

IR transient thermography is a versatile nondestructive testing technique that relies upon temporal measurements of heat transference through an object to provide information concerning the structure and integrity of the object. Because heat flow through an object is substantially unaffected by the micro-structure and the single-crystal orientations of the material of the object, an IR transient thermography analysis is essentially free of the limitations this creates for ultrasonic measurements, which are another type of nondestructive evaluation used to determine wall thickness. In contrast to most ultrasonic techniques, a transient thermographic analysis approach is not significantly hampered by the size, contour or shape of the object being tested and, moreover, can be accomplished ten to one-hundred times faster than most conventional ultrasonic methods if testing objects of large surface area.

One known contemporary application of transient thermography, which provides the ability to determine the size and “relative” location (depth) of flaws within solid non-metal composites, is revealed in U.S. Pat. No. 5,711,603 to Ringermacher et al., entitled “Nondestructive Testing: Transient Depth Thermography.” Basically, this technique involves heating the surface of an object of interest and recording the temperature changes over time of very small regions or “resolution elements” on the surface of the object. These surface temperature changes are related to characteristic dynamics of heat flow through the object, which is affected by the presence of flaws. Accordingly, the size and a value indicative of a “relative” depth of a flaw (i.e., relative to other flaws within the object) can be determined based upon a careful analysis of the temperature changes occurring at each resolution element over the surface of the object.

To obtain accurate thermal measurements using transient thermography, the surface of an object must be heated to a particular temperature in a sufficiently short period of time, so as to preclude any significant heating of the remainder of the object. Depending on the thickness and material characteristics of the object under test, a quartz lamp or a high intensity flash-lamp is conventionally used to generate a heat pulse of the proper magnitude and duration. Once the surface of the object is heated, a graphic record of thermal changes over the surface is acquired and analyzed.

Conventionally, an IR video camera has been used to record and store successive thermal images (frames) of an object surface after heating it. Each video image is composed of a fixed number of pixels. In this context, a pixel is a small picture element in an image array or frame, which corresponds to a rectangular area, called a “resolution element” on the surface of the object being imaged. Because the temperature at each resolution element is directly related to the intensity of the corresponding pixel, temperature changes at each resolution element on the object surface can be analyzed in terms of changes in pixel contrast. The contrast data for each pixel is then analyzed in the time domain (i.e., over many image frames) to identify the time of occurrence of an “inflection point” of the contrast curve data, which is mathematically related to a relative depth of a flaw within the object.

As noted above, data acquisition begins after the surface of the object being inspected is heated by an IR flash. A conventional IR flash is shown in FIG. 8. As shown in FIG. 8, the flash has an exponential tail, which continues to heat the surface of the object. When imaging thin parts, early frames must be analyzed and cannot be discarded. As used here, “early frames” refer to the frames at the beginning of a sequence of images. However, the thermal information in the early frames is distorted by the exponential tail of the flash because the exponential tail continues to heat the surface of the object during acquisition of the early frames. Consequently, the analysis of thin objects using IR thermography is currently limited due to the exponential tail of the flash.

Accordingly, it would be desirable to control the duration of the flash for IR thermography. Moreover, it would be desirable to actively control the duration of the flash for IR thermography, so that the desired flash duration may be selected for a given application.

### BRIEF DESCRIPTION

Briefly, in accordance with one embodiment of the present invention, an actively quenched lamp includes a lamp and an active quenching means configured to quench the lamp.

An infrared (“IR”) thermography imaging system embodiment is also disclosed. The IR thermography imaging system includes at least one lamp configured to heat a surface of an object to be imaged, at least one active quenching means configured to quench the at least one lamp, and an IR camera configured to capture a number of IR image frames of the object.

A method embodiment, for actively controlling a duration of a flash for IR thermography, is also disclosed. The method includes generating an initial control signal T0, a lamp control signal T1, and a control signal T2. The method further includes activating a quenching means in response to the initial control signal T0, to allow current I to flow to a lamp, activating the lamp in response to the lamp trigger signal T1, and turning off the quenching means in response to the control signal T2 to cut off the current I to the lamp.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an actively quenched lamp embodiment of the invention, in block form;

FIG. 2 shows an exemplary timing diagram for the actively quenched lamp of FIG. 1;

FIG. 3 shows an example of an active quenching means, in block form;

FIG. 4 shows exemplary circuitry for the actively quenched lamp of FIGS. 1 and 3;

FIG. 5 shows a quenched flash that was cut off at 20 ms;

FIG. 6 shows a quenched flash that was cut off at 10 ms;

FIG. 7 shows a quenched flash that was cut off at 2 ms;

FIG. 8 shows an unquenched flash; and

FIG. 9 illustrates an infrared thermography imaging system embodiment of the invention.

### DETAILED DESCRIPTION

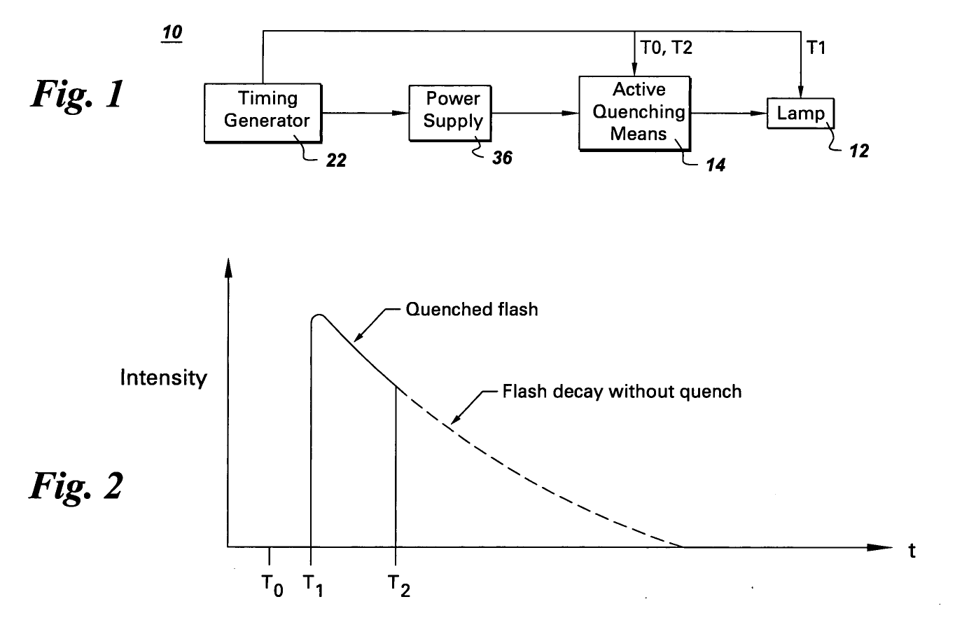

An actively quenched lamp 10 embodiment of the invention is described first with reference to FIGS. 1 and 2. As shown in FIG. 1, the actively quenched lamp 10 includes a lamp 12, and an active quenching means 14 configured to quench the lamp. Exemplary lamps 12 include quartz lamps and high power flash lamps driven by a power supply 36 and used for transient infrared imaging, such as halogen lamps, flash lamps, and arc lamps. One commercially available high power flash lamp is a Speedotron model 105 flash lamp, which can be driven by a Speedotron 4803, 4.8 Kilojoule (KJ) power supply, both of which are manufactured by Speedotron Corp., Chicago, Ill.

The active quenching means 12 may be a discrete component of the actively quenched lamp 10, as shown in FIG. 1. Another configuration would be to include the active quenching means 12 within another component, for example, within the power supply 36 driving the lamp 12.

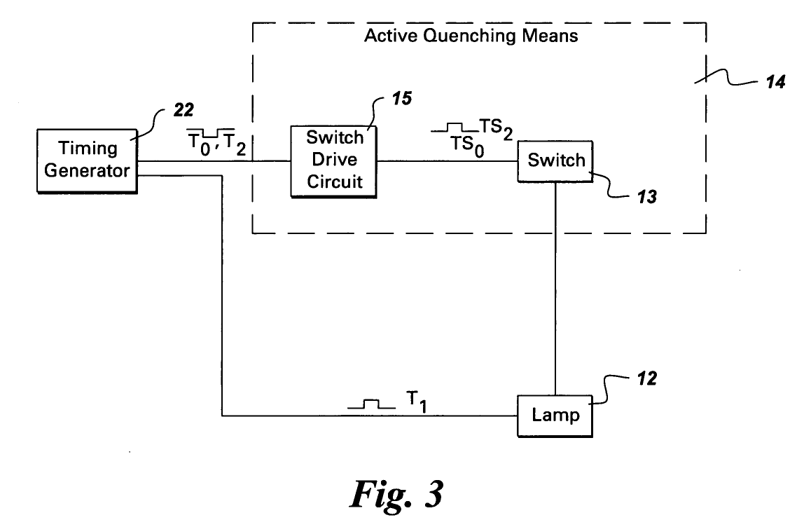

FIG. 2 is an exemplary timing diagram for the actively quenched lamp 10. As indicated in FIGS. 1 and 2, the active quenching means 14 is configured to receive an initial control signal T0 and to allow current I to flow to the lamp 12 in response to the initial control signal T0. As used herein, the term “configured” means being equipped with circuitry, software and/or hardware for performing the stated function. In addition, the active quenching means 14 is configured to receive a control signal T2 and to quench the lamp 12 in response to the control signal T2. As indicated in FIG. 3, for example, exemplary control signals T2 and T0 are the high and low portions, respectively, of a pulse signal.

For the embodiment of FIG. 1, the actively quenched lamp 10 includes a timing generator 22 configured to supply the initial control and control signals T0, T2. The timing generator 22 may also supply a lamp trigger signal T1 to activate the lamp 12. An exemplary timing generator 22 is a computer. It should be noted that the present invention is not limited to any particular computer. The term “computer” is intended to denote any machine that is capable of accepting a structured input and of processing the input in accordance with prescribed rules to produce an output. One exemplary computer 22 is a specially programmed, general purpose digital computer that is capable of peripheral equipment control and communication functions, in addition to digital image processing and display.

The decay time constant T of the lamp 12 is typically characterized by a resistance R and a power supply capacitance C. The time constant T governs the decay time for a flash. As shown in FIG. 2 by the dashed line, without quenching, the flash has an exponential tail. This exponential tail would continue to heat the object during data acquisition, thereby distorting the thermal information in the data frames. A quenched flash is shown by the solid line. As shown, the flash has a duration D of about D=T2−T1. The desired duration D varies by application and is long enough to heat the surface of the object being inspected but short enough to end prior to acquisition of the data frames. An exemplary flash pulse has a desired duration of about 2 milliseconds. Beneficially, by cutting off the exponential tail (shown by the dashed line in FIG. 2), the active quenching means 14 reduces distortion of the thermal information in the data frames. In turn, reducing the distortion of the thermal information in the data frames permits a more accurate analysis.

More particularly, the desired pulse duration is equal to the infrared camera frame period used for the particular application. For example, if the camera operates at 500 frames per second (FPS), the frame period is 0.002 seconds, and the desired pulse duration should be set to 2 ms plus the appropriate pre-flash duration.

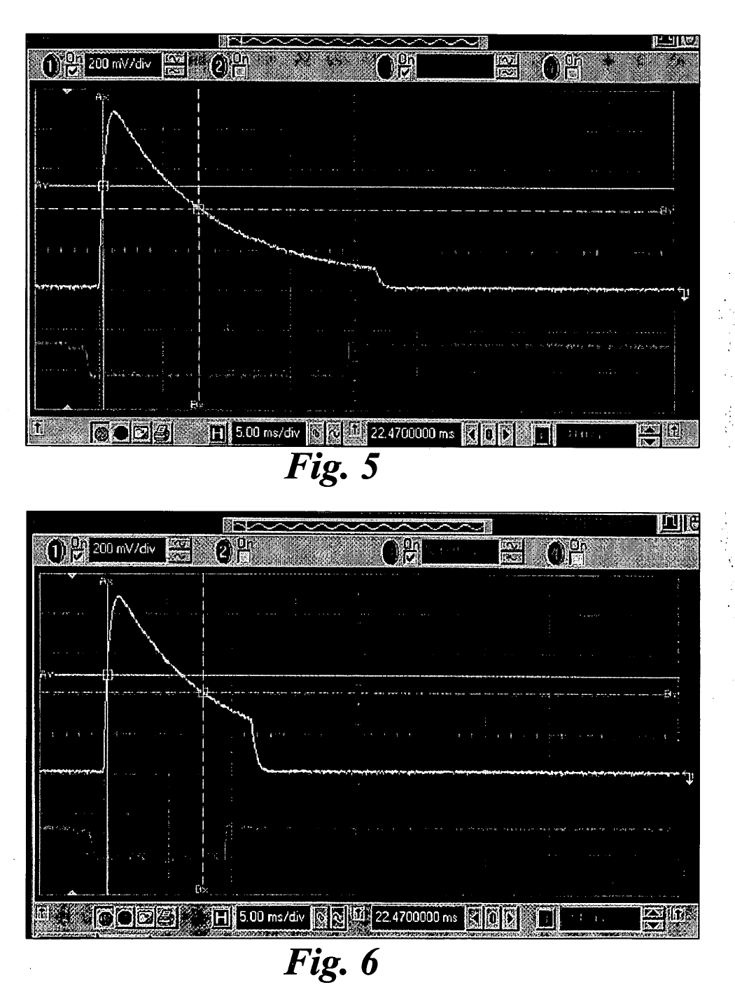

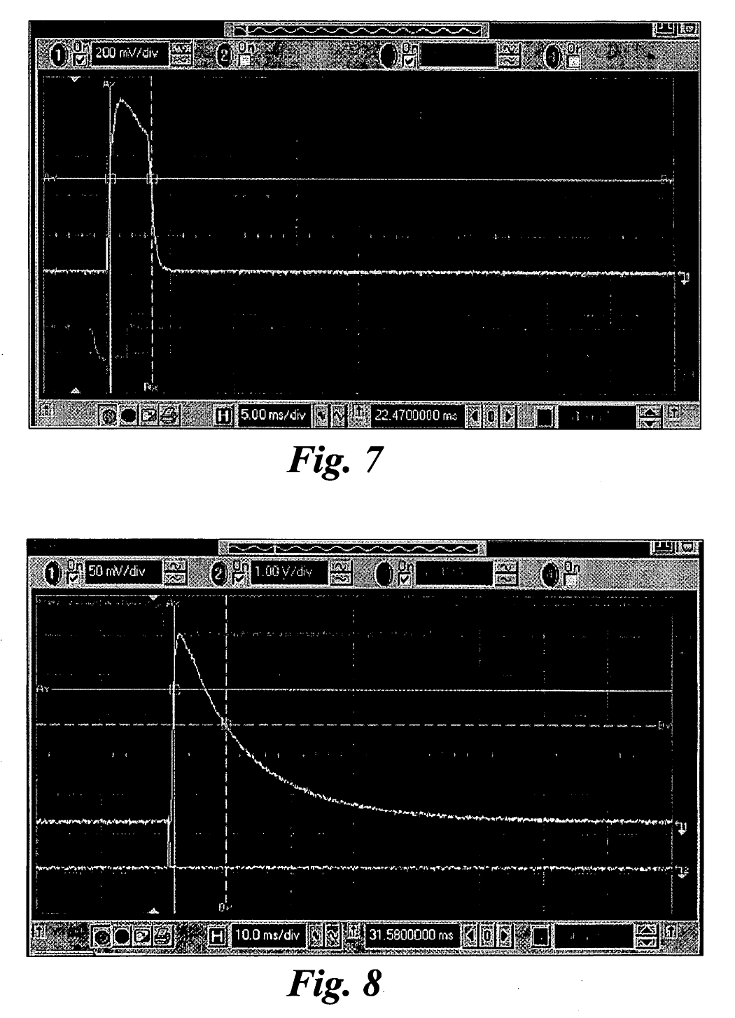

Exemplary quenched flashes are shown in FIGS. 5-7, and an exemplary unquenched flash is shown in FIG. 8. The quenched flashes in FIGS. 5-7 were cut off at 20 ms, 10 ms, and 2 ms, respectively. The flashes were monitored using a high-speed photodiode (not shown) and a digital storage scope (also not shown). FIGS. 5-8 demonstrate variable quenching collateral with the applied gate pulse.

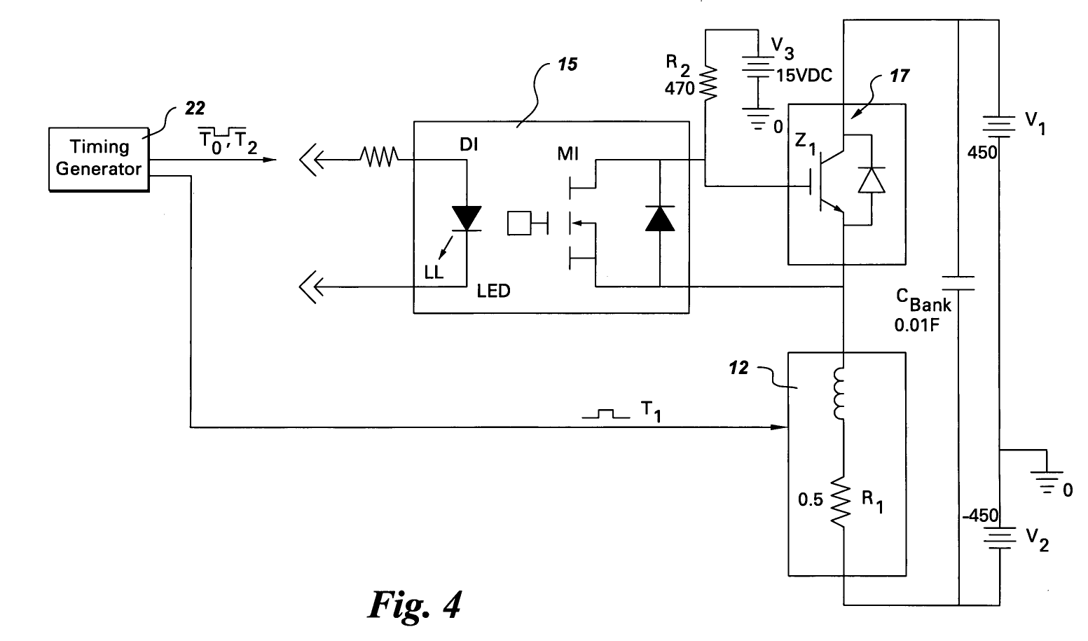

FIG. 3 shows an exemplary active quenching means 14 in block form. As shown, the active quenching means 14 includes a high-voltage, high current switch 13. The switch 13 closes in response to the initial control signal T0, allowing current flow to the lamp 12, and opens in response to the control signal T2, quenching the lamp 12. Exemplary high-voltage, high current switches 13 include power semiconductor switches, such as an insulated gate bipolar transistor “IGBT” 17, as shown for example in FIG. 4, a silicon controlled rectifier (not shown), a gate turn-on thryristor (not shown), MOSFETS (not shown), and an integrated gate commutated thyristor (“IGCT”) (not shown). Beneficially, an IGBT 17 has a large current, large voltage standoff handling capacity. In addition, the IGBT 17 is relatively easy to control using its voltage-controlled gate.

For the exemplary embodiment of FIG. 4, the IGBT 17 collector-emitter is in series with the lamp 12 current supply-line. As noted above, the IGBT 17 has a voltage-controlled gate, which is turned on by an appropriate gate voltage V_{G}. This closes the lamp circuit, allowing current I to flow to the lamp 12 and the flash to initiate. For the example shown in FIG. 4, a gate driver was used to apply a 15 V delay-adjusted gate signal to the IGBT 17. The end of the gate pulse, adjusted by the timing generator (or delay generator) 22, opens the lamp circuit, thereby cutting off the exponential tail of the flash at a chosen delay time, in order to produce a more rectangular shaped optical pulse, as indicated in FIG. 2 by the solid line.

For the embodiments of FIGS. 3 and 4, the active quenching means 14 further includes a switch drive circuit 15 (or “gate drive circuit” 15) configured to receive a logic level signal and to generate a switch-drive signal in response. Exemplary logic level signals include TTL, CMOS, and emitter coupled logic (ECL) signals. Exemplary switch drive circuits 15 include an opto-coupler (as shown) and a logic level buffer and level shifter (not shown). An exemplary switch-drive signal is a voltage signal with sufficient magnitude to activate or deactivate a voltage-controlled switch 13, such as IGBT 17. For this embodiment, the initial control signal T0 and the control signal T2 are logic level signals, and the high-voltage, high current switch 13 (here an IGBT 17) closes in response to the switch-drive voltage signal TS0 that corresponds to the initial control signal T0 and opens in response to the switch-drive voltage signal TS2 that corresponds to the control signal T2. Other exemplary switch-drive circuits 15 are configured to receive a logic level signal and to generate a switch-drive current signal in response, to activate or deactivate a current-controlled switch.

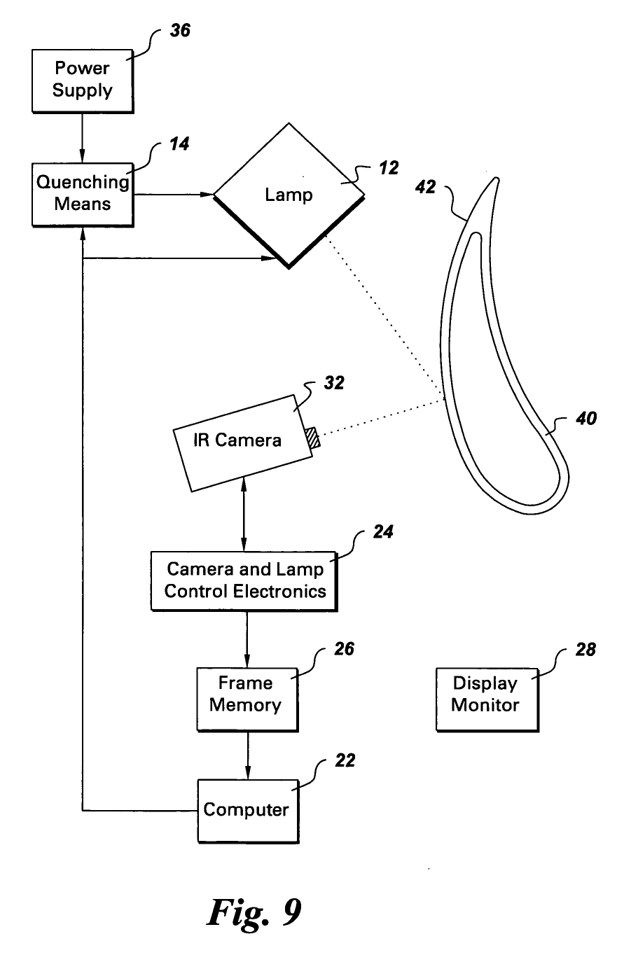

An infrared (“IR”) thermography imaging system 30 is described with reference to FIG. 9. As shown, the IR thermography imaging system 30 includes at least one lamp 12 configured to heat a surface 42 of an object 40 to be imaged. Although the exemplary object shown in FIG. 9 is an airfoil, the object 40 may take any form. The imaging system 30 also includes at least one active quenching means 14 configured to quench the at least one lamp 12, and an IR camera 32 configured to capture a number of IR image frames of the object 40. The active quenching means 14 and lamp 12 are described above.

Depending on the size, thickness and other factors of the object 40, several lamps 12 may be used to rapidly heat the surface 42. For example, one suitable arrangement for the lamp(s) 12 is a set of four or eight high speed, high output power photographic flash lamps, each capable of about 4.8 Kilojoules output and having individual power supplies (such as manufactured by Speedotron. Corp., of Chicago, Ill.).

An exemplary IR camera 36 is an IR video camera configured to record and store successive thermal images (frames) of the object surface 42 after heating by the lamp(s) 12. For example, the IR camera may be an IR sensitive focal-plane camera available from Indigo Systems in Goleta, Calif.

For the IR thermography imaging system 30 embodiment of FIG. 9, the system 30 further includes a timing generator 22, such as a computer, which is configured to supply the initial control signal T0 and the control signal T2 to the quenching means 14. The timing generator 22 may be further configured to supply a lamp trigger signal T1 to activate the lamp 12.

Camera and lamp control electronics 24 may be managed by video frame software running on the computer 22. As noted above, an exemplary computer 22 is a specially programmed, general purpose digital computer that is capable of peripheral equipment control and communication functions, in addition to digital image processing and display. For the embodiment of FIG. 9, the computer 22 controls the camera and lamp electronics 24 and frame data memory 26 to acquire a predetermined number of successive thermal image frames of the object surface 42, which are stored in the frame data memory 26 for future analysis. In addition, a display monitor 28 may be provided.

A method embodiment of the invention, for actively controlling a duration of a flash for IR thermography, is also disclosed. The method includes generating an initial control signal T0, a lamp control signal T1, and a control signal T2. A quenching means 14 is activated in response to the initial control signal T0 to allow current I to flow to a lamp 12. The lamp is activated in response to the lamp trigger signal T1. The quenching means is turned off in response to the control signal T2, in order to cut off the current I to the lamp.

According to a more particular embodiment of the method, the initial control signal T0 and the control signal T2 are logic level signals, such as TTL, CMOS, and emitter coupled logic (ECL) signals. For this embodiment, the method also includes generating switch-drive signals TS0 and TS2 in response to the control signals T0 and T2, respectively. The quenching means is turned off by opening a switch in response to the switch-drive signal TS2 and is turned on by closing the switch in response to the switch drive signal TS0. According to a particular embodiment, the switch is voltage-controlled, and the switch-drive signals TS0 and TS2 are voltage signals.

Although only certain features of the invention have been illustrated and described herein, many modifications and changes will occur to those skilled in the art. It is, therefore, to be understood that the appended claims are intended to cover all such modifications and changes as fall within the true spirit of the invention.

1. An actively quenched lamp comprising:
a lamp; and
an active quenching means configured to quench said lamp.

2. The actively quenched lamp of claim 1, wherein said active quenching means is configured to receive a control signal T2 and to quench said lamp in response to the control signal T2.

3. The actively quenched lamp of claim 2, wherein said active quenching means comprises a high-voltage, high current switch, wherein said high-voltage, high current switch opens in response to the control signal T2.

4. The actively quenched lamp of claim 3, wherein said active quenching means is further configured to receive an initial control signal T0, and wherein said high-voltage, high current switch closes in response to the initial control signal T0.

5. The actively quenched lamp of claim 3, further comprising a timing generator configured to supply the control and initial control signals T2, T0 and to supply a lamp trigger signal T1, wherein said lamp is activated in response to the lamp trigger signal T1.

6. The actively quenched lamp of claim 3, wherein said timing generator comprises a computer.

7. The actively quenched lamp of claim 3, wherein said active quenching means further comprises a switch drive circuit configured to receive a logic level signal and to generate a switch-drive signal in response, wherein the control signal T2 is a logic level signal, and wherein said high-voltage, high current switch opens in response to the switch-drive signal TS2 that corresponds to the control signal T2.

8. The actively quenched lamp of claim 7, wherein the switch-drive signal TS2 is a switch-drive voltage signal TS2.

9. The actively quenched lamp of claim 3, wherein said high-voltage, high current switch comprises a power semiconductor switch.

10. The actively quenched lamp of claim 3, wherein said high-voltage, high current switch comprises an insulated gate bipolar transistor (IGBT).

11. The actively quenched lamp of claim 9, wherein the power semiconductor switch is selected from the group consisting of a silicon controlled rectifier, a gate turn-on thryristor, a MOSFET, a insulated gate commutated thyristor (“IGCT”), and combinations thereof.

12. The actively quenched lamp of claim 1, wherein said lamp comprises a halogen lamp.

13. The actively quenched lamp of claim 1, wherein said lamp comprises a flash lamp.

14. The actively quenched lamp of claim 1, wherein said lamp comprises an arc lamp.

15. An infrared (“IR”) thermography imaging system comprises:
at least one lamp configured to heat a surface of an object to be imaged;
at least one active quenching means configured to quench said at least one lamp; and
an IR camera configured to capture a plurality of IR image frames of the object.

16. The IR thermography imaging system of claim 15, wherein said active quenching means is configured to receive an initial control signal T0 and a control signal T2, and wherein said active quenching means is further configured to allow a current flow I to said lamp in response to the initial control signal T0 and to quench said lamp in response to the control signal T2.

17. The IR thermography imaging system of claim 16, wherein said active quenching means comprises a high-voltage, high current switch, wherein said high-voltage, high current switch closes in response to the initial control signal T0 and opens in response to the control signal T2.

18. The IR thermography imaging system of claim 17, further comprising a timing generator configured to supply the initial control signal T0 and the control signal T2 and to supply a lamp trigger signal T1, wherein said lamp is activated in response to the lamp trigger signal T1.

19. The IR thermography imaging system of claim 16, wherein said active quenching means further comprises a switch drive circuit configured to receive a logic level signal and to generate a switch-drive signal in response, wherein the control signal T2 is a logic level signal, and wherein said high-voltage, high current switch opens in response to the switch-drive signal that corresponds to the control signal T2.

20. The IR thermography imaging system of claim 19, wherein the switch-drive signal is a switch-drive voltage signal.

21. The IR thermography imaging system of claim 17, wherein said high-voltage, high current switch comprises a power semiconductor switch.

22. The IR thermography imaging system of claim 17, wherein said high-voltage, high current switch comprises an insulated gate bipolar transistor.

23. The IR thermography imaging system of claim 22, wherein said lamp comprises a halogen lamp.

24. The IR thermography imaging system of claim 22, wherein said lamp comprises a flash lamp.

25. A method for actively controlling a duration of a flash for infrared (“IR”) thermography, said method comprising:
generating an initial control signal T0, a lamp control signal T1, and a control signal T2;
activating a quenching means in response to the initial control signal T0 to allow current I to flow to a lamp; activating the lamp in response to the lamp trigger signal T1; and
turning off the quenching means in response to the control signal T2 to cut off the current I to the lamp.

26. The method of claim 25, wherein the initial control signal T0 and the control signal T2 comprise logic level signals, and wherein said method further comprises:
generating a switch-drive signal TS2 in response to the control signal T2,
wherein said turning off the quenching means comprises opening a switch in response to the switch-drive signal TS2.

27. The method of claim 26, wherein the switch-drive signal TS2 is a switch-drive voltage signal TS2.
